(19) United States
(12) Patent Application Publication
(10) Pub. No.: US 2006/0182520 A1
(43) Pub. Date: Aug. 17, 2006

(54) Backlining sticking apparatus

(75) Inventor: Kazuo Shibuya, Nagano (JP)

Correspondence Address: GREENBLUM & BERNSTEIN, P.L.C., 1950 ROLAND CLARKE PLACE, RESTON, VA, 20191, US

(73) Assignee: Shibuya Bunsenkaku Co., Ltd., Nagano (JP)

(21) Appl. No.: 11/268,589

(22) Filed: Nov. 8, 2005

(30) Foreign Application Priority Data
Feb. 1, 2005 (JP) 2005-024711

(51) Int. Cl. B42C 9/00

(52) U.S. Cl. 412/8

(57) ABSTRACT

A backlining sticking apparatus includes a cover supplying mechanism that supplies a cover for a hollowback book to an upstream side of a conveying path in a state where the cover is not bent, a conveying mechanism that conveys the cover supplied by the cover supplying mechanism downstream on the conveying path, an adhesive applying mechanism that applies adhesive with a width that is at least equal to a width of a spine part of a content of the hollowback book onto a center part of a surface of the cover conveyed on the conveying path, a paper folding mechanism that continuously shapes belt-like paper into a flattened tube with a width that is equal to the applied width of the adhesive, a backlining fabricating mechanism that fabricates a backlining by cutting the tube-like paper shaped by the paper folding mechanism into a predetermined length, and a backlining sticking mechanism that is disposed downstream of the adhesive applying mechanism and sticks the backlining to a position on the cover where the adhesive has been applied.

### BACKGROUND OF THE INVENTION

1. Field of the Invention

The present invention relates to a backlining sticking apparatus used when manufacturing hollowback books.

2. Description of the Related Art

A manufacturing apparatus for a book cover assembly disclosed by Japanese Laid-Open Patent Publication No. H09-71064 is known as one example of this type of backlining sticking apparatus. According to this manufacturing apparatus, a book cover assembly where a support piece is attached to the rear surface of a book cover by two or four lines of adhesive applied to the rear surface can be manufactured automatically without requiring manual labor. Also, when manufacturing a book using the book cover assembly manufactured in this way, the spine part of a leaf block is stuck to the support piece of the book cover assembly using adhesive. By doing so, it is possible to integrate the leaf block and the cover via the support piece, thereby completing a book. A book manufactured in this way has the same construction as the book disclosed by Japanese Laid-Open Patent Publication No. H08-324153, is easy to open, and does not suffer from the center part of the open left and right pages rising upwards or from the pages bending by themselves, and therefore makes the published content easy to read.

However, when the book of the construction described above is bound on a bookbinding production line, when both sides of the cover that have been attached to the support piece are bent toward the support piece, sagging occurs for the support piece positioned on the inside. Such sagging causes problems such as unsightliness and a reduction in strength. To solve such problems, a hollowback book disclosed by Japanese Laid-Open Patent Publication No. H11-170732 has been proposed. In place of the support piece used by the book disclosed by Japanese Laid-Open Patent Publication No. H08-324153 described above, a book is constructed by integrating the cover and the leaf block using a backlining in the shape of a flattened tube that is wider than the spine part of the leaf block. According to the book of this construction, even if sagging occurs for the backlining when the cover is bent during the binding process, such sagging can be shifted to both ends of the flattened tube, thereby avoiding the production of wrinkles.

By investigating the manufacturing apparatus for the book cover assembly disclosed by Japanese Laid-Open Patent Publication No. H09-71064 described above, the present inventor discovered the following problems. That is, the fabrication of a tube-like backlining and the process of sticking the fabricated backlining onto the cover, which are required for manufacturing a hollowback book disclosed by Japanese Laid-Open Patent Publication No. H11-170732, cannot be carried out by the manufacturing apparatus for the book cover assembly disclosed by Japanese Laid-Open Patent Publication No. H09-71064 described above and inevitably have to be carried out manually. Accordingly, to raise the efficiency of the fabrication of the tube-like backlining and the sticking process for the backlining, and in turn to increase the bookbinding efficiency, the fabrication of the tube-like backlining and the sticking process for the backlining should preferably be automated.

### SUMMARY OF THE INVENTION

To solve the problems described above, it is a principal object of the present invention to provide a backlining sticking apparatus that enables the fabrication of a tube-like backlining and the process of sticking the backlining onto a cover to be automated.

A backlining sticking apparatus according to the present invention includes: a cover supplying mechanism that supplies a cover for a hollowback book to an upstream side of a conveying path in a state where the cover is not bent; a conveying mechanism that conveys the cover supplied by the cover supplying mechanism downstream on the conveying path; an adhesive applying mechanism that applies adhesive with a width that is at least equal to a width of a spine part of a content of the hollowback book to a center part of a surface of the cover conveyed on the conveying path; a paper folding mechanism that continuously shapes belt-like paper into a flattened tube with a width that is equal to the applied width of the adhesive; a backlining fabricating mechanism that fabricates a backlining by cutting the tube-like paper shaped by the paper folding mechanism into a predetermined length; and a backlining sticking mechanism that is disposed downstream of the adhesive applying mechanism and sticks the backlining to a position on the cover where the adhesive has been applied.

According to the above backlining sticking apparatus, the adhesive applying mechanism can automatically apply adhesive with a width that is at least equal to the width of a spine part of a content of the hollowback book to a center part of a surface of the cover, the paper folding mechanism can continuously fabricate, from belt-like paper, backlinings in the form of flattened tubes with a width that is equal to the applied width of the adhesive, and the backlining sticking mechanism can stick the backlining onto the center part of the surface of the cover. This means that it is possible to automate the fabrication of a cover that has a backlining, which is in the form of a flattened tube with a width that is at least equal to the width of the spine part of the content, stuck to a center part of the surface thereof, and therefore the cover can be efficiently fabricated. Accordingly, it is also possible to efficiently fabricate a hollowback book where the spine part of the content is attached to the center part of the cover via a backlining that is tube-like in shape and has a width that is at least equal to the width of the spine part.

Also, in the backlining sticking apparatus according to the present invention, the backlining sticking mechanism may include a suction drum that is freely rotatable about an axis along a direction perpendicular to the conveying direction of the cover, is disposed so that an outer circumferential surface thereof is capable of contacting the surface of the cover conveyed on the conveying path, attaches the backlining fabricated by the backlining fabricating mechanism to the outer circumferential surface thereof by suction, conveys the backlining onto the conveying path, and sticks the backlining onto the surface of the cover.

According to the above backlining sticking apparatus, by constructing the backlining sticking mechanism so as to include the suction drum described above, it is possible to attach the backlining to the cover gradually from a leading end of the backlining in the direction of rotation of the suction drum. For this reasons the backlining can be attached to the cover with no air bubbles remaining between the backlining and the cover.

Also, in the backlining sticking apparatus according to the present invention, the backlining sticking mechanism may include an endless belt that contacts the outer circumferential surface of the suction drum and may convey the attached backlining onto the conveying path in a state where the backlining is held between the outer circumferential surface of the suction drum and the endless belt.

According to the above backlining sticking apparatus, by constructing the backlining sticking mechanism as described above, it is possible to stick the backlining shaped into a tube to the surface of the cover in a state where the backlining remains flattened. For this reason, it is possible to reliably avoid a situation where wrinkles are produced in one end of the backlining that faces the cover that would occur if the backlining contacted the cover in a non-flat state, and therefore the backlining can be neatly stuck to the cover.

It should be noted that the disclosure of the present invention relates to a content of Japanese Patent Application 2005-024711 that was filed on 1 Feb. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view of a hollowback book when looking from an upper surface side thereof;

FIG. 2 is an exploded plan view showing the construction of the hollowback book;

FIG. 3 is an exploded perspective view showing the construction of the hollowback book;

FIG. 4 is a plan view showing the hollowback book in a state where the content is opened, when looking from an upper surface side of the hollowback book;

FIG. 5 is a front elevation of a backlining sticking apparatus;

FIG. 6 is a plan view of the backlining sticking apparatus;

FIG. 7 is a plan view of a shaping mechanism;

FIG. 8 is a front elevation of an inner shaping plate in the shaping mechanism;

FIG. 9 is a cross-sectional view along a line S-S in FIG. 7;

FIG. 10 is a cross-sectional view along a line T-T in FIG. 7;

FIG. 11 is a cross-sectional view along a line U-U in FIG. 7;

FIG. 12 is a cross-sectional view along a line V-V in FIG. 7;

FIG. 13 is a front elevation of a suction drum;

FIG. 14 is a cross-sectional view showing the construction of another hollowback book from an upper surface thereof;

FIG. 15 is an exploded plan view showing the construction of the hollowback book shown in FIG. 14; and

FIG. 16 is a plan view showing, from above, the hollowback book shown in FIG. 14 in a state where the content is opened.

### DESCRIPTION OF THE PREFERRED EMBODIMENTS

Preferred embodiments of a backlining sticking apparatus according to the present invention used when manufacturing a hollowback book will now be described with reference to the attached drawings.

First, the construction of a hollowback book 1 will be described with reference to the drawings.

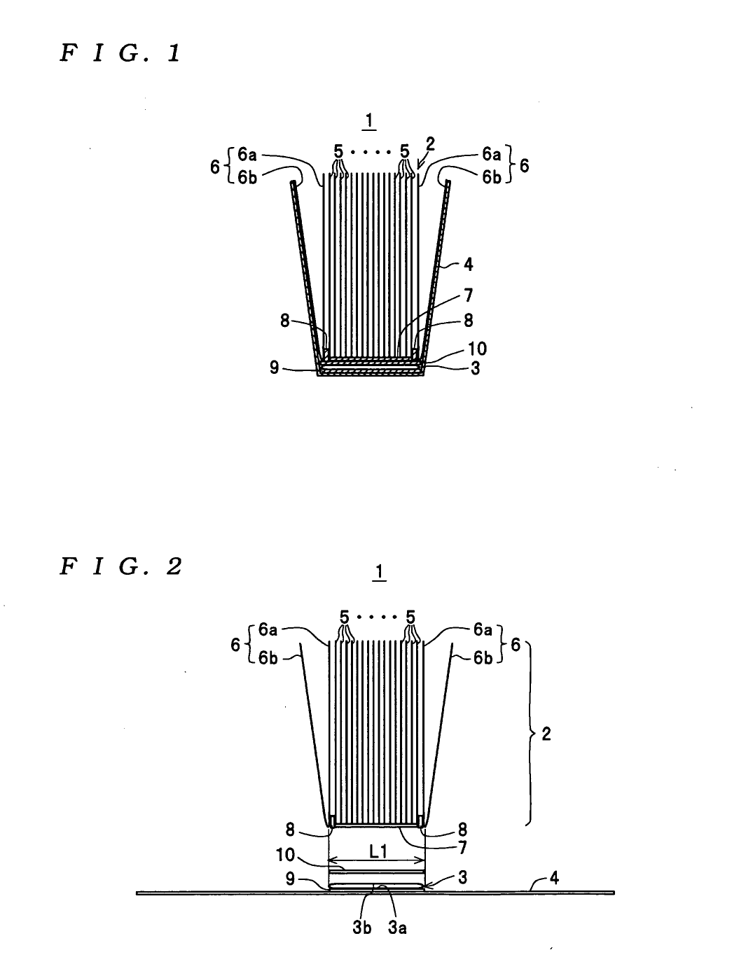

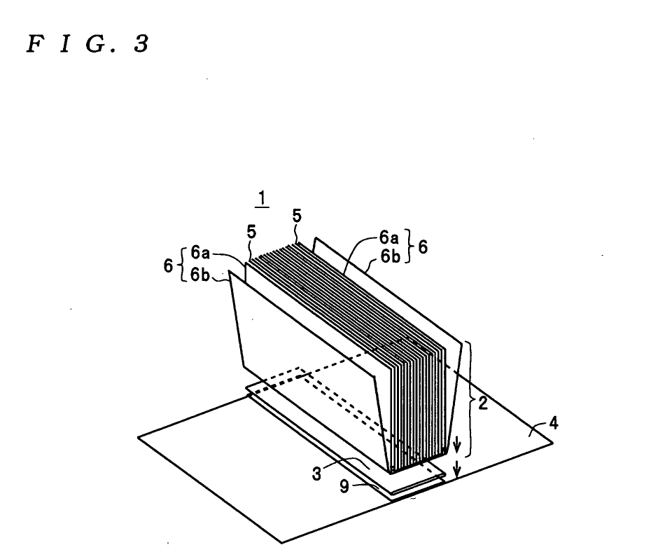

As shown in FIGS. 1 and 2, the hollowback book 1 includes a content 2, a backlining (gutter) 3, and a cover 4, and is constructed as a softcover book. The content 2 is composed of a plurality of leaves 5 and a pair of endpapers 6 disposed at respective ends of the leaves 5, the leaves 5 and the endpapers 6 being joined into a single body at a spine part thereof (at the lower ends of the drawings). More specifically, as shown in FIGS. 1 and 2, the plurality of leaves 5 are joined into a single body by adhesive 7 at the lower ends of the respective leaves 5. In this case, the endpapers 6 are papers that are stuck to the inside of the covers to join the content and the covers and are respectively formed by bending single sheets in half. Also, lower ends of positions 6a of the respective endpapers 6 that face fly leaves (white pages that are not printed upon and are disposed in front of and behind the content) are respectively joined to lower ends of the leaves 5 that function as the fly leaves by adhesive (for example, hot melt adhesive) 8.

As one example, as shown in FIGS. 1 and 2, the backlining 3 is formed in the shape of a flattened tube using a strong paper material such as craft paper, backlining cloth, or Japanese paper, and is attached to corresponding positions on the spine part of the content 2 and the cover 4. By doing so, the spine part of the content 2 and corresponding positions on the cover 4 are connected via the backlining 3. Also, as shown in FIG. 2, the width L1 of the backlining 3 in the flattened state is set equal (or substantially equal) to the width of the spine part of the content 2. Here, the backlining 3 is fabricated so as to maintain the tube-like state by itself, such as by overlapping and bonding together the edges at both ends in the width direction when the back lining 3 has been bent into a flattened tube. However, the construction is not limited to this, and the backlining 3 only needs to be formed in a tube in the state where the backlining 3 is attached to the cover 4. Accordingly, in a state where the backlining 3 is wound into a tube by itself, the facing edge parts do not need to be bonded together. Also, as described later, when the content 2 is opened, more stress is applied to a second end 3b of the backlining 3 that faces the spine part of the content 2 than a first end 3a that faces the cover 4. For this reason, to sufficiently withstand such large stress, the backlining 3 should preferably be disposed so that the respective edge parts of the backlining 3 that face one another are positioned on the cover 4 side. The cover 4 is used to wrap the content 2 and as one example is fabricated using a paper, such as speciality paper, used for soft cover books.

When fabricating the hollowback book 1 using the component elements described above, first, as shown in FIGS. 2 and 3, adhesive (for example, emulsion or glue) 9 is applied in a straight line with the same width as the width of the spine part of the content 2 (i.e., the width of the backlining 3) at a position on the surface of the cover 4 facing the spine part of the content 2, and more specifically a central position (the “spine” of the cover) on the surface of the cover 4. Next, the first end 3a of the backlining 3 is stuck (attached) to the position where the adhesive 9 has been applied onto the cover 4. At this time, the backlining 3 is stuck on so that the edge parts that face one another are oriented toward the cover 4. After this, using adhesive 10 such as a reactive hot melt adhesive, the spine part of the content 2 is attached to the surface of the second end 3b of the backlining 3. Finally, the positions 6b that become paste papers of the endpapers 6 of the content 2 are attached to the respectively corresponding inner surfaces of the cover 4 using an adhesive, not shown. By doing so, the fabrication of the hollowback book 1 is completed.

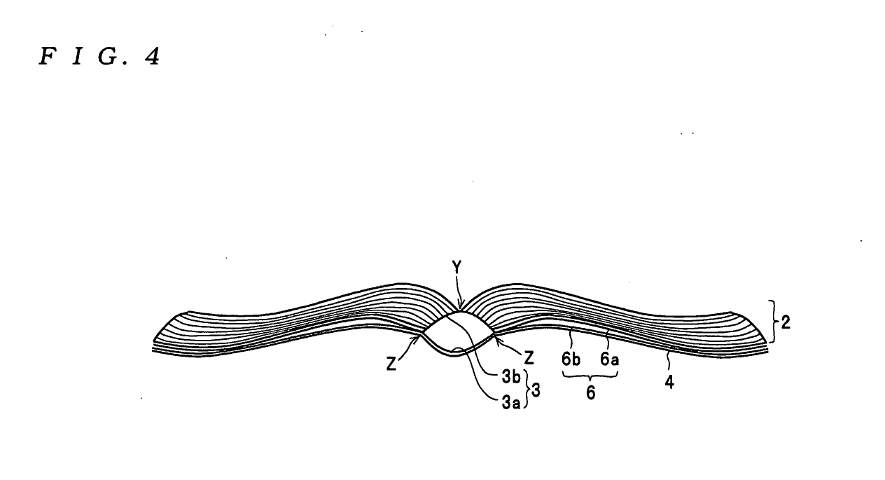

For the hollowback book 1 fabricated in this way, the width of the backlining 3 is set equal to the width of the spine part of the content 2, and the spine of the cover 4 is reinforced by attaching the first end 3a of the backlining 3. For this reason, as shown in FIG. 4, in a state where the content 2 is opened to the left and right, one side (the left side) and another side (the right side) of the content 2 fall to the left and right with the respective ends Z of the spine of the cover 4 (both sides of the spine of the cover 4, that is, the respective folds of the cover) as supporting points. At this time, the spine of the cover 4 that is hardly bent presses open an end (a position joined to one of the end parts Z of the cover 4 along the length of the spine of the cover 4) on one side of the content 2 and an end (a position joined to the other end part Z of the cover 4 along the length of the spine of the cover 4) on the other side of the content 2 with a boundary position Y between the one side and the other side of the content 2 as a supporting point, resulting in the second end 3b of the backlining 3 that is attached to the spine part of the content 2 also maintaining a state where the backlining 3 is hardly bent. Accordingly, at the second end 3b that is attached to the spine part of the content 2, a concentration of stress due to bending at a sharp angle does not occur for the hollowback book 1, and therefore the second end 3b of the backlining 3 can be formed so as to be resistant to tearing. As a result, it is possible to prevent the backlining 3 tearing at the second end 3b that is attached to the spine part of the content 2.

Next, a backlining sticking apparatus 21 that can automatically fabricate the backlining 3 that is the characteristic part of the hollowback book 1 described above and stick the backlining 3 onto the cover 4 of the hollowback book 1 will be described with reference to the drawings.

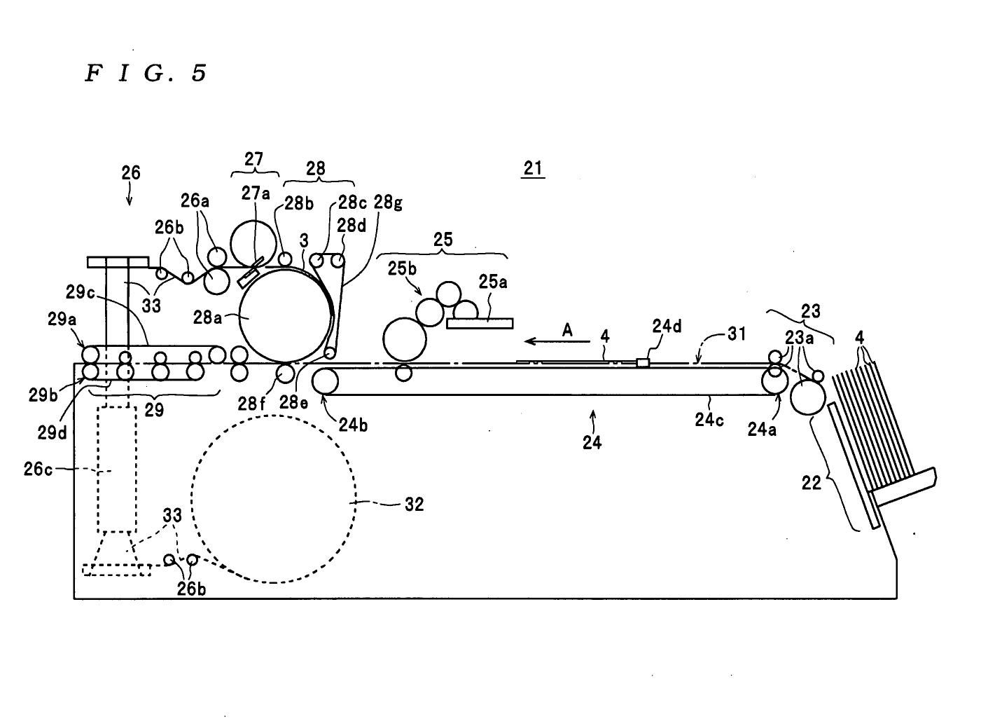

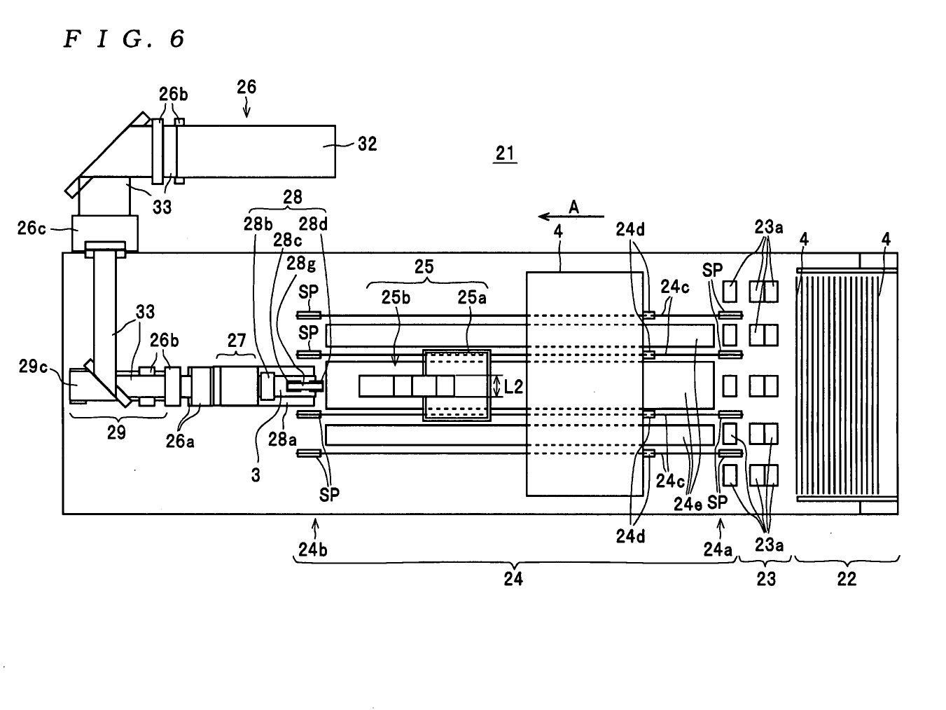

First, the construction of the backlining sticking apparatus 21 will be described with reference to FIGS. 5 and 6.

As shown in the drawings, the backlining sticking apparatus 21 includes a cover stocking mechanism 22, a cover supplying mechanism 23, a conveying mechanism 24, an adhesive applying mechanism 25, a paper folding mechanism 26, a backlining fabricating mechanism 27, a backlining sticking mechanism 28, a pressing mechanism 29, and a driving source, not shown, for connecting and driving the respective mechanisms. The backlining sticking apparatus 21 is constructed so as to automatically stick the backlining 3 onto the surface of the cover 4.

As shown in FIG. 5, the cover stocking mechanism 22 is disposed at a furthest upstream position on a conveying path 31 (shown by the dot-dash line in FIG. 5) of the cover 4 and stocks a plurality of covers 4 in a non-bent state. The cover supplying mechanism 23 is disposed downstream of the cover stocking mechanism 22 (but on the upstream side when looking at the entire conveying path 31) and as one example is composed of a suction device (not shown) and a plurality of feed rollers 23a. In addition, the cover supplying mechanism 23 is driven by the driving source so that the covers 4 from the cover stocking mechanism 22 are picked up by suction one at a time by the suction device and the picked-up cover 4 is supplied by the feed rollers 23a to the upstream side of the conveying path 31 (more specifically, a conveying start position on the conveying mechanism 24).

The conveying mechanism 24 is disposed downstream of the cover supplying mechanism 23 on the conveying path 31 and conveys the cover 4 supplied from the cover supplying mechanism 23 in a substantially horizontal state in a straight line downstream along the conveying path 31. Here, the cover 4 is conveyed in the direction of the arrow A shown in FIGS. 5 and 6. More specifically, as shown in FIG. 5, the conveying mechanism 24 includes a first sprocket group 24a disposed downstream of the cover supplying mechanism 23 and below the conveying path 31, a second sprocket group 24b disposed below a midway part of the conveying path 31, a plurality of chains 24c, a plurality of feed hooks 24d, and a plurality of support guides 24e. As shown in FIGS. 5 and 6, the first sprocket group 24a and the second sprocket group 24b are disposed in parallel on the same horizontal plane and as one example respectively include four sprockets SP. The respective rotational shafts of the sprockets SP are perpendicular to the conveying direction A. The chains 24c are suspended between the facing sprockets SP in the first sprocket group 24a and the second sprocket group 24b. The feed hooks 24d are attached to the corresponding chains 24c so as to be positioned on a straight line that is perpendicular to the conveying direction A of the cover 4. As shown in FIG. 6, the support guides 24e are disposed between the chains 24c and support the cover 4 on the conveying path 31 inside the conveying mechanism 24. In the conveying mechanism 24 with the construction described above, by having the first sprocket group 24a and the second sprocket group 24b rotationally driven in concert by the driving source in the anticlockwise direction in FIG. 5, the feed hooks 24d continuously move on an endless track together with the chains 24c, and when the feed hooks 24d move on the upper track in FIG. 5, the cover 4 on the support guides 24e is pushed along in the conveying direction A.

As shown in FIGS. 5 and 6, the adhesive applying mechanism 25 is disposed above a downstream part of the conveying mechanism 24 at a center part in a width direction thereof, and is composed of a palette 25a that stores adhesive and a roller group 25b including a plurality of adhesive applying rollers. Here, the rotational shafts of the plurality of adhesive applying rollers are disposed in a direction that is perpendicular to the conveying direction A of the cover 4 and as shown in FIG. 6, the length L2 of the adhesive applying rollers is set equal to or wider than the width of the spine part of the content 2 of the hollowback book 1. According to this construction, the adhesive applying mechanism 25 is driven by the driving source and the adhesive 9 (see FIGS. 2 and 3) is applied in a straight line to a central part of the surface of the cover 4 conveyed on the conveying path 31 with an applied width that is equal to or wider than the width of the spine part of the hollowback book 1 (i.e., the width of the spine part of the content 2). In the present embodiment, as one example, since the length L2 of the plurality of adhesive applying rollers is set equal to the width of the spine part of the content 2, the adhesive applying mechanism 25 applies the adhesive 9 to the cover 4 with an applied width that is equal to the width of the spine part of the content 2. It should be noted that the adhesive applying mechanism 25 is constructed so that at least the final adhesive applying roller (the adhesive applying roller that finally applies the adhesive 9 to the surface of the cover 4) can be replaced, and therefore the adhesive 9 can be applied with a freely chosen applied width.

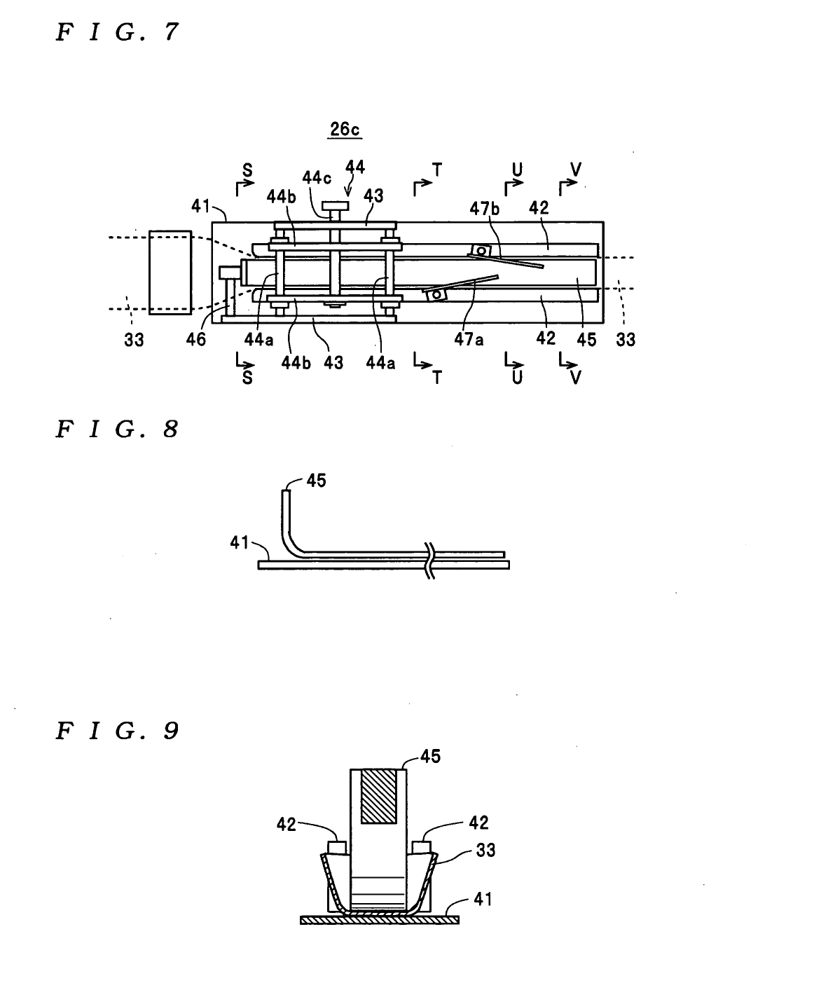

As shown in FIGS. 5 and 6, the paper folding mechanism 26 is composed of a pair of feed rollers 26a, a plurality of tension rollers 26b, and a shaping mechanism 26c. In the paper folding mechanism 26, the pair of feed rollers 26a are driven by the driving source to feed out, for example, craft paper 33 (craft paper of a width that exceeds double the width of the spine part of the content 2) in a belt-like state from a paper roll (as a specific example, a craft paper roll) 32 and the fed out craft paper 33 is continuously shaped in a flattened tube with the same width as the applied width of the adhesive 9 in the shaping mechanism 26c. More specifically, as shown in FIG. 7, the shaping mechanism 26c includes a base plate 41, a pair of outer shaping plates 42, a pair of support walls 43, a width adjusting mechanism 44, an inner shaping plate 45, a support arm 46, and a pair of pressing plates 47a, 47b. In this case, the base plate 41 is formed with a flat surface as the upper surface and is disposed along the conveying direction of the craft paper 33. The pair of outer shaping plates 42 are disposed in parallel on the base plate 41 so as to sandwich the craft paper 33. The pair of outer shaping plates 42 are supported by the width adjusting mechanism 44 that is attached to the pair of support walls 43 disposed on either side of the respective outer shaping plates 42.

The width adjusting mechanism 44 includes a pair of linear guides 44a suspended between the pair of support walls 43 along a direction perpendicular to the conveying direction of the craft paper 33, a pair of slides 44b that are guided by the pair of linear guides 44a and are freely movable in a direction perpendicular to the conveying direction of the craft paper 33, and an adjustment screw 44c on whose surface a male screw thread is formed and is screwed into female screw holes (not shown) formed in the respective slides 44b. Here, the screw formation direction of respective regions of the male screw thread of the adjustment screw 44c that is screwed into the female screw holes of the slides 44b is set so that as one example, when the adjustment screw 44c is rotated in the clockwise direction, the slides 44b approach one another while when the adjustment screw 44c is rotated in the anticlockwise direction, the slides 44b move away from one another. Also, the respective outer shaping plates 42 are attached to the slides 44b. According to this construction, by rotating (operating) the adjustment screw 44c of the width adjusting mechanism 44, the outer shaping plates 42 approach or move away from one another while remaining in parallel.

As shown in FIG. 7, the inner shaping plate 45 is formed of a plate that is long and has a fixed width, and as shown in FIG. 8, the inner shaping plate 45 is bent at one end (the side where the craft paper 33 is introduced). Also, as shown in FIG. 7, the inner shaping plate 45 is supported by one of the support walls 43 by the tip of the bent end of the inner shaping plate 45 being linked to the support arm 46 that extends from such support wall 43, and is disposed between the pair of outer shaping plates 42. Here, as shown in FIG. 8, the inner shaping plate 45 is disposed facing the base plate 41 with a gap through which the craft paper 33 can pass being formed between the inner shaping plate 45 and the base plate 41. The width of the craft paper 33 in the form of a flattened tube (that is, the width of the backlining 3) is determined by the width of the inner shaping plate 45. Accordingly, the width of the inner shaping plate 45 is set in accordance with the width of the backlining 3. Also, to make the width of the inner shaping plate 45 precisely match the width of the backlining 3, the outer shaping plates 42 are moved by operating the adjustment screw 44c of the width adjusting mechanism 44 so that the gap between the outer shaping plates 42 and the inner shaping plate 45 is set in advance so as to be somewhat wider than the thickness of the craft paper 33. The pair of pressing plates 47a, 47b are attached to the respective outer shaping plates 42 in a state where the front ends of the pressing plates 47a, 47b extend upwards at the other end of the inner shaping plate 45. It should be noted that although not shown in the drawings, a mechanism that applies adhesive (for example, emulsion or glue) at one end in the width direction of the craft paper 33 is disposed just before the width adjusting mechanism 44. By doing so, on the craft paper 33 formed in a tube by the width adjusting mechanism 44, edge parts at both ends in the width direction that overlap one another are attached by the applied adhesive.

As shown in FIG. 5, the backlining fabricating mechanism 27 includes a cutter 27a and by cutting the craft paper 33 formed into a tube by the paper folding mechanism 26 in predetermined lengths (in more detail, there are no particular limitations on the length, but as one example a length that is equal to the height of the hollowback book 1 or slightly shorter) using the cutter 27a, the backlinings 3 are continuously fabricated and supplied to the backlining sticking mechanism 28.

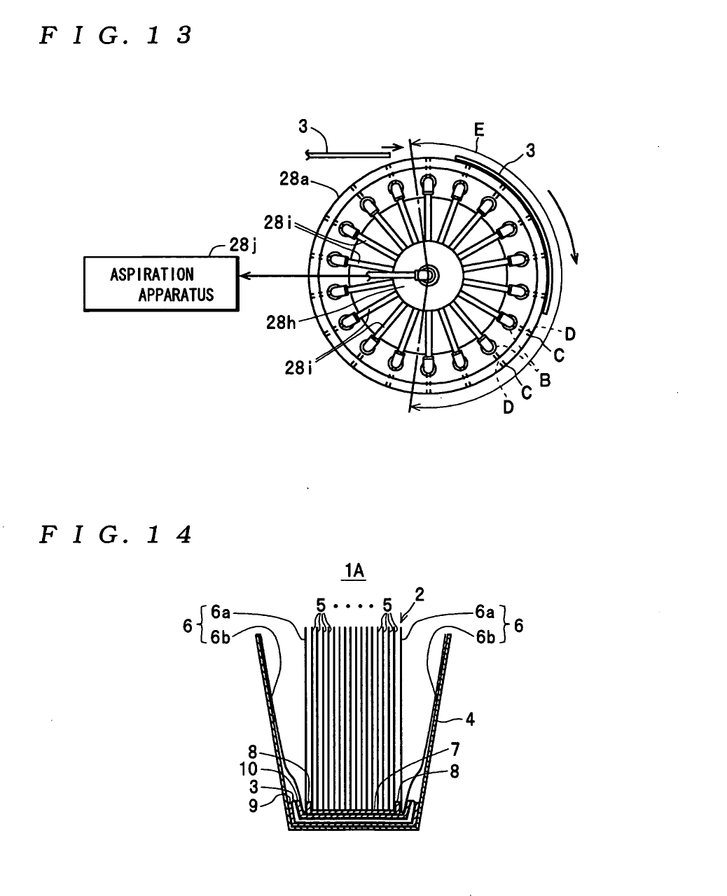

As shown in FIG. 5, the backlining sticking mechanism 28 includes a suction drum 28a, a plurality of pulleys (in the present embodiment, five) 28b, 28c, 28d, 28e, and 28f, an endless belt 28g, a switching valve 28h (see FIG. 13), a plurality of suction tubes 28i (see FIG. 13), and an aspiration apparatus 28j (see FIG. 13), and is disposed above the conveying path 31 downstream of the adhesive applying mechanism 25 on the conveying path 31. The suction drum 28a is formed as a cylindrical body, is freely rotatable about an axis disposed along a direction that is perpendicular to the conveying direction A of the cover 4, and is disposed so that the outer circumferential surface thereof is capable of contacting the surface of the cover 4 conveyed on the conveying path 31. The suction drum 28a can also attach a backlining 3 to the outer circumferential surface using suction in a state where the length direction of the backlining 3 matches the circumferential direction of the suction drum 28a, conveys the attached backlining 3 toward the conveying path 31, and sticks the backlining 3 onto the surface of the cover 4. Here, the rotational velocity of the suction drum 28a is set so that the peripheral velocity of the outer circumferential surface matches the conveying velocity of the cover 4 on the conveying path 31.

More specifically, as shown in FIG. 13, a plurality of exhaust holes B are formed in one end surface of the suction drum 28a on a circle centered on the axis of the suction drum 28a. Also, the same number of suction holes C as the exhaust holes B are formed along the circumference direction in the outer circumferential surface of the suction drum 28a. Additionally, the same number of ducts D as the exhaust holes B for connecting the respective suction holes C and the respective exhaust holes B are formed inside the suction drum 28a. The switching valve 28h is disposed on the axis of the suction drum 28a and rotates together with the suction drum 28a. The switching valve 28h is connected to the suction drum 28a via the plurality of suction tubes 28i that are connected to the respective exhaust holes B of the suction drum 28a. The switching valve 28h is also connected to the aspiration apparatus 28j. Here, after the respective suction holes C formed in the suction drum 28a that rotates (rotation in the direction shown by the arrow in FIG. 13) have reached the highest point shown in FIG. 13, the switching valve 28h connects the respective suction holes C and the aspiration apparatus 28j via the respective suction tubes 28i until the lowest point is reached (i.e., only while the suction holes C are located within the region E, for example). With this construction, as shown in FIG. 13, the suction drum 28a attaches the backlining 3 supplied from the backlining fabricating mechanism 27 using suction at the highest point and releases the backlining 3 after conveying at the lowest point.

As shown in FIG. 5, the plurality of pulleys 28b to 28f are disposed so that the respective axes thereof are parallel to the axis of the suction drum 28a. The pulley 28b is disposed so as to contact the outer circumferential surface of the upper part of the suction drum 28a. The pulleys 28c, 28d are disposed at positions above the suction drum 28a and are closer to the adhesive applying mechanism 25 than the pulley 28b, with the pulleys 28c, 28d being in front of and behind each other along the conveying direction A of the cover 4. The pulley 28e is disposed below the pulleys 28c and 28d. The pulley 28f is disposed so as to contact the outer circumferential surface of the lower part of the suction drum 28a. The endless belt 28g is suspended on the three pulleys 28c, 28d, and 28e, and is disposed so that a suction drum 28a-side thereof makes surface contact with the outer circumferential surface of the adhesive applying mechanism 25-side of the suction drum 28a. According to this construction, in the backlining sticking mechanism 28, a backlining 3 supplied from the backlining fabricating mechanism 27 is attached to the suction drum 28a by suction and the attached backlining 3 is held between the endless belt 28g and the suction drum 28a and conveyed while maintaining a flattened state until the backlining 3 reaches the conveying path 31 and is supplied to the surface of the cover 4. Also, with the backlining sticking mechanism 28, at a position where the backlining 3 first contacts the surface of the cover 4 (the lowest point of the suction drum 28a), the backlining 3 and the cover 4 are fed downstream on the conveying path 31 while being pressed together between the suction drum 28a and the pulley 28f.

As shown in FIG. 5, the pressing mechanism 29 includes roller groups 29a and 29b that are respectively disposed above and below the conveying path 31 and a pair of endless belts 29c, 29d that are respectively suspended on the roller groups 29a and 29b. The pressing mechanism 29 conveys the backlining 3 and the cover 4 sent from the backlining sticking mechanism 28 further while pressing the backlining 3 and the cover 4 together, thereby further improving the attachment of the backlining 3 to the cover 4 and forming the backlining 3 in a flattened shape once again.

Next, the sticking operation for sticking the backlining 3 onto the cover 4 using the backlining sticking apparatus 21 will be described.

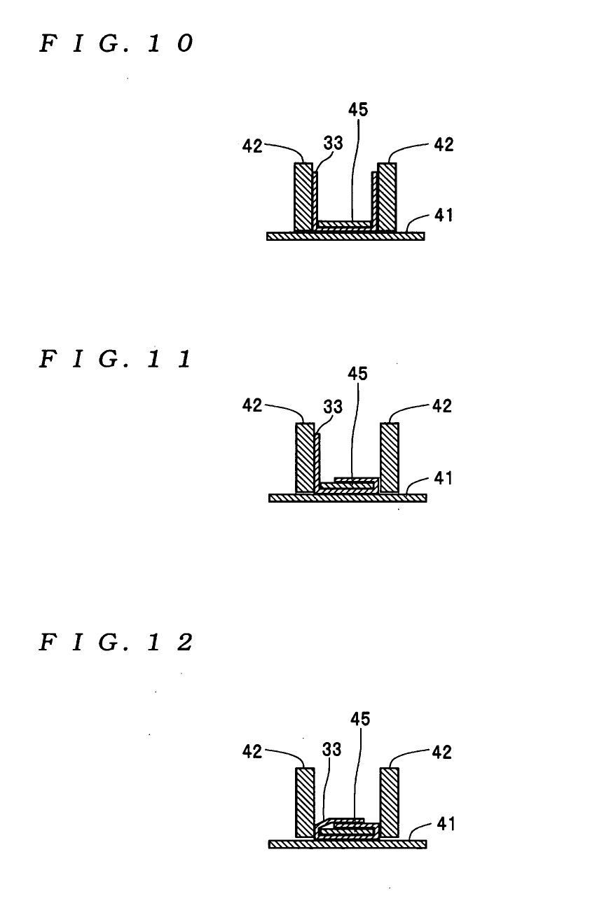

In the backlining sticking apparatus 21, the cover supplying mechanism 23 takes the covers 4 from the cover stocking mechanism 22 one at a time and supplies a cover 4 to the conveying mechanism 24. The conveying mechanism 24 pushes the trailing end of the cover 4 with the feed hooks 24d to convey the cover 4 in the conveying direction A. The adhesive applying mechanism 25 applies the adhesive 9 (see FIGS. 2 and 3) in a straight line with an equal width to the width of the spine part of the content 2 to a center part of the surface of the cover 4 conveyed by the conveying mechanism 24. On the other hand, the paper folding mechanism 26 feeds out the craft paper 33 from the paper roll 32 in synchronization with the supply timing of the cover 4 from the cover supplying mechanism 23 and shapes the fed-out craft paper 33 into a flattened tube that has substantially the same width as the spine part of the content 2. More specifically, as shown in FIG. 9, in the paper folding mechanism 26, a central part of the fed craft paper 33 in the width direction is pressed by the inner shaping plate 45 so that both end parts of the craft paper 33 in the width direction are bent toward the inner shaping plate 45, thereby shaping the craft paper 33 into a U-shape in cross-section. Next, as shown in FIG. 10, the pair of outer shaping plates 42 further bend both end parts of the craft paper 33, which have been folded upward, toward the center of the craft paper 33 that is being pressed by the inner shaping plate 45 so that both end parts become bent at substantially right angles. Next, as shown in FIG. 11, the pressing plate 47a bends a first of the bent ends of the craft paper 33 onto the inner shaping plate 45 and then, as shown in FIG. 12, the pressing plate 47b bends the second of the bent ends of the craft paper 33 onto the first of the bent ends that has been bent onto the inner shaping plate 45. By doing so, the craft paper 33 introduced into the backlining sticking apparatus 21 is shaped into a flattened tube and is led out of the backlining sticking apparatus 21.

Next, the backlining fabricating mechanism 27 cuts the craft paper 33 that has been shaped into a flattened tube into a predetermined length in synchronization with the supply timing of the cover 4 to fabricate a backlining 3 and supplies the fabricated backlining 3 to the backlining sticking mechanism 28. The backlining sticking mechanism 28 attaches the backlining 3 to the outer circumferential surface of the suction drum 28a at the highest point of the suction drum 28a using suction, conveys the backlining 3 to the conveying path 31 (the lowest point of the suction drum 28a), and then releases the backlining 3, thereby attaching the backlining 3 to the cover 4. At this time, in the backlining sticking mechanism 28, by having the backlining 3 pass between the suction drum 28a and the endless belt 28g, the backlining 3 is tightly attached to the suction drum 28a and is shaped in an arc, with the backlining 3 being gradually attached (stuck) to the adhesive 9 on the surface of the cover 4 that is conveyed on the conveying path 31 starting from a leading edge of the backlining 3 in the direction of rotation of the suction drum 28a. By doing so, the backlining 3 is attached to the cover 4 while preventing air bubbles from remaining between the backlining 3 and the cover 4. The pressing mechanism 29 conveys the cover 4 on which the backlining 3 has been stuck between the pair of endless belts 29c and 29d while the roller groups 29a and 29b press the backlining 3 and the cover 4 together, further improving the attachment of the backlining 3 to the cover 4 and shaping the backlining 3 in a flattened state once more, while discharging the cover 4 from the backlining sticking apparatus 21. By doing so, the fabrication of the cover 4 to which the backlining 3 for the hollowback book 1 is attached (stuck) is completed.

In this way, according to the backlining sticking apparatus 21, by including the component elements described above, the adhesive applying mechanism 25 automatically applies the adhesive 9 to a center part of the surface of the cover 4 in a straight line with an equal width to the width of the spine part of the content 2, the paper folding mechanism 26 continuously and automatically fabricates, from the belt-like craft paper 33, the backlinings 3 in the form of flattened tubes with an equal width to the width of the spine part of the content 2, and the backlining sticking mechanism 28 can automatically stick a backlining 3 onto the center part of the surface of the cover 4. This means that it is possible to automate the fabrication of covers 4 that have the backlinings 3 in the form of flattened tubes with the same width as the width of the spine part of the content 2 stuck to a center part of the respective surfaces thereof, and therefore the covers 4 can be fabricated efficiently. Accordingly, even the hollowback book 1 where the spine part of the content 2 is attached to the center part of the cover 4 via the backlining 3 formed as a tube with the same width as the spine part of the content 2 can be efficiently fabricated. Also, by attaching the backlining 3 using the suction drum 28a, it is possible to gradually attach the backlining 3 to the cover 4 from the leading edge of the backlining 3 in the direction of rotation of the suction drum 28a, and as a result it is possible to attach the backlining 3 to the cover 4 without leaving air bubbles between the backlining 3 and the cover 4.

In addition, by constructing the backlining sticking mechanism 28 so that the backlining 3 is conveyed onto the conveying path 31 in a state where the backlining 3 is held between the outer circumferential surface of the suction drum 28a and the endless belt 28g, it is possible to stick the backlining 3 formed in a tube onto the surface of the cover 4 while maintaining the flattened state. This means that it is possible to reliably avoid the production of wrinkles on one side of the backlining 3 facing the cover 4 that would happen if the backlining 3 contacted the cover 4 in a non-flattened state, and therefore the backlining 3 can be neatly stuck to the cover 4.

It should be noted that the present invention is not limited to the above construction. For example, although an example has been described where in the backlining sticking apparatus 21 described above, the applied width with which the adhesive 9 is applied onto the cover 4 by the adhesive applying mechanism 25 is set equal to the width of the spine part of the content 2 and the width L1 of the backlining 3 is set equal to the applied width of the adhesive 9 (the width of the spine part of the content 2) by the paper folding mechanism 26 so that a cover 4 that has the backlining 3, which is in the form of a flattened tube with the same width as the width of the spine part of the content 2, stuck on a center part of the surface thereof can be fabricated efficiently, the present invention is not limited to this construction. For example, in the backlining sticking apparatus 21, by changing the width of the inner shaping plate 45 and the distance between the pair of outer shaping plates 42 in the paper folding mechanism 26 to a length that exceeds the width of the spine part of the content 2 and changing the length L2 of the plurality of adhesive applying rollers in the adhesive applying mechanism 25 (or at least the length of the final adhesive applying roller) in the same way, it is possible to efficiently fabricate a cover 4 (see FIG. 15) where a backlining 3 with a width L1 that exceeds the width of the spine part of the content 2 (or a width L1 that is narrower than the width of the spine part of the content 2) is stuck onto a center part of the surface of the cover 4.

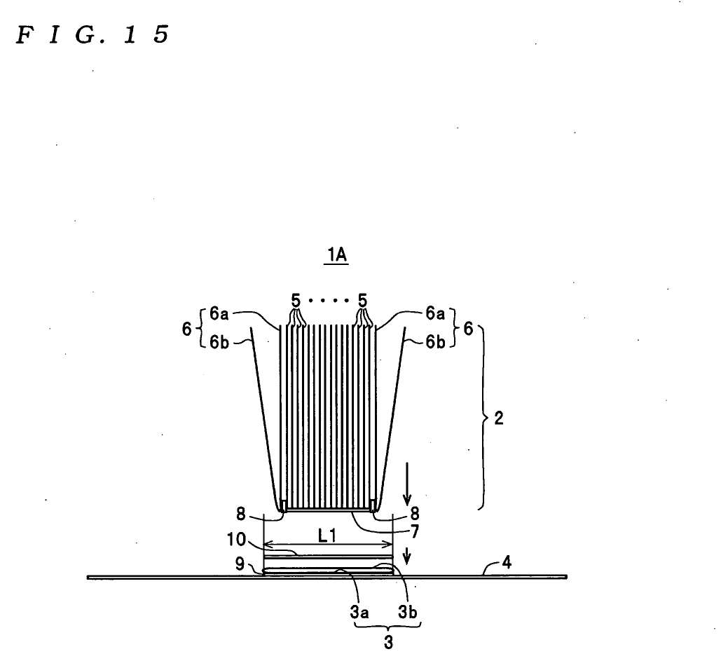

Next, a hollowback book 1A fabricated using a cover 4 manufactured by the backlining sticking apparatus 21 set (changed) in this way will be described in brief. It should be noted that aside from the width L1 of the backlining 3 and the applied width of the adhesive 9 on the cover 4 being widths that exceed the width of the spine part of the content 2 as shown in FIGS. 14 and 15, the hollowback book 1A has the same construction as the hollowback book 1. For this reason, parts with the same construction as the hollowback book 1 have been assigned the same numerals and description thereof has been omitted.

As shown in FIG. 14, the hollowback book 1A includes a content 2, a backlining 3, and a cover 4 and is constructed as a soft cover book. When manufacturing the hollowback book 1A, first, as shown in FIG. 15, adhesive 10 is applied to the entire surface of the second end 3b of the backlining 3 that has been fabricated by the backlining sticking apparatus 21 and attached to a center position of the cover 4 and then the spine part of the content 2 is attached by the adhesive 10 to the surface of the second end 3b of the backlining 3. Finally, the positions 6b of the respective endpapers 6 of the content 2 that become the paste papers are respectively attached to the corresponding inner surfaces of the cover 4 using adhesive, not shown. By doing so, the fabrication of the hollowback book 1A is completed.

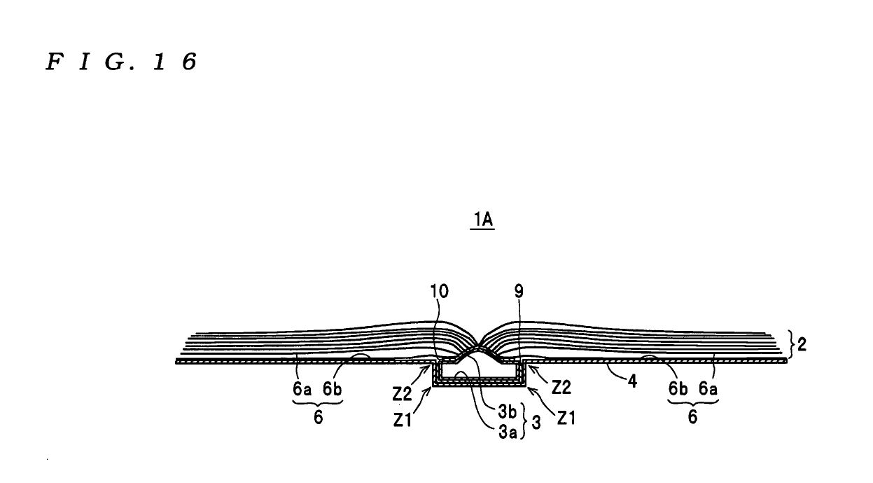

In the hollowback book 1A, the width L1 of the backlining 3 is set at a length that exceeds the width of the spine part of the content 2. For this reason, as shown in FIG. 16, in a state where the content 2 is opened to the left and right, the cover 4 bends in the center part thereof at respective folds Z1 formed by contact with respective corners of the spine part of the content 2 when the content 2 is closed and also bends to the left and right at folds Z2 that are positioned further outside the folds Z1 and face the respective folds of the backlining 3. Accordingly, for the hollowback book 1A, both corners of the spine part of the content 2 move so as to approach one another, resulting in the content 2 remaining in the opened state.

It should be noted that the present invention is not limited to the above construction. For example, although the hollowback books 1 and 1A have been described without indicating the type of soft cover book, it should be obvious that the present invention can be applied to soft cover books bound by a perfect binding, a notch binding, a sewn temporary binding, or the like. Also, although the conveying mechanism 24 in the construction described above conveys the cover 4 using the chains 24c, it is possible to use a conveying mechanism that uses belts in place of the chains 24c. It should also be obvious that the applied width of the adhesive 9, 10 (the relationship with the width of the spine part of the content 2) and the method of applying (for example, application across the entire range of the applied region or partial application) may be changed as appropriate.

What is claimed is:

1. A backlining sticking apparatus comprising:
a cover supplying mechanism that supplies a cover for a hollowback book to an upstream side of a conveying path in a state where the cover is not bent;
a conveying mechanism that conveys the cover supplied by the cover supplying mechanism downstream on the conveying path;
an adhesive applying mechanism that applies adhesive, with a width that is at least equal to a width of a spine part of a content of the hollowback book, onto a center part of a surface of the cover conveyed on the conveying path;
a paper folding mechanism that continuously shapes belt-like paper into a flattened tube with a width that is equal to the applied width of the adhesive;
a backlining fabricating mechanism that fabricates a backlining by cutting the tube-like paper shaped by the paper folding mechanism into a predetermined length; and
a backlining sticking mechanism that is disposed downstream of the adhesive applying mechanism and sticks the backlining to a position on the cover where the adhesive has been applied.

2. A backlining sticking apparatus according to claim 1,
wherein the backlining sticking mechanism includes a suction drum that is freely rotatable about an axis along a direction that is perpendicular to the conveying direction of the cover, is disposed so that an outer circumferential surface thereof is capable of contacting the surface of the cover conveyed on the conveying path, attaches the backlining fabricated by the backlining fabricating mechanism to the outer circumferential surface thereof by suction, conveys the backlining onto the conveying path, and sticks the backlining to the surface of the cover.

3. A backlining sticking apparatus according to claim 2,
wherein the backlining sticking mechanism includes an endless belt that contacts the outer circumferential surface of the suction drum and the backlining sticking mechanism conveys the attached backlining to the conveying path in a state where the backlining is held between the outer circumferential surface of the suction drum and the endless belt.
